(19) United States
(12) Patent Application Publication
(10) Pub. No.: US 2026/0140471 A1
(43) Pub. Date: May 21, 2026

(54) IMAGE FORMING APPARATUS

(71) Applicant: Konica Minolta, Inc., Tokyo (JP)

(72) Inventors: Kei Kiyama, Tokyo (JP); Hisashi Okuno, Tokyo (JP)

(73) Assignee: Konica Minolta, Inc., Tokyo (JP)

(21) Appl. No.: 19/389,179

(22) Filed: Nov. 14, 2025

(30) Foreign Application Priority Data
Nov. 15, 2024 (JP) 2024-199803

(51) Int. Cl. G03G 15/00; G03G 15/01; G03G 15/16

(52) U.S. Cl. CPC G03G 15/5029; G03G 15/0131; G03G 15/0189; G03G 15/1615; G03G 15/6558; G03G 2215/00548; G03G 2215/00717

(57) ABSTRACT

Provided is an image forming apparatus including: a transferor that includes a transfer body and a pressing roller which hold a recording material between the transfer body and the pressing roller, where the transfer body transfers an image onto the recording material, the pressing roller presses the transfer body, and the recording material is conveyed; a characteristic detector that detects characteristic information corresponding to a recording material characteristic of the recording material that is conveyed to the transferor; and a controller that performs adjustment, in which a pressing force of the pressing roller against the transfer body or an interval between the transfer body and the pressing roller is adjusted, at the transferor based on the detected characteristic information.

### CROSS REFERENCE TO RELATED APPLICATIONS

The entire disclosure of Japanese Patent Application No. 2024-199803, filed on November 15, 2024, is incorporated herein by reference in its entirety.

### BACKGROUND

### Technological Field

The present invention relates to an image forming apparatus.

### Description of Related Art

In the related art, an image forming apparatus of an intermediate transfer method has been widespread in which a toner image formed on a photoreceptor (image carrier) is primarily transferred onto an intermediate transfer belt (an image carrier and an intermediate transfer body) and the toner image on the intermediate transfer belt is secondarily transferred onto a sheet.

At the secondary transfer position, a transferor is disposed which includes a support roller supporting the intermediate transfer belt from the inside thereof and a transfer roller pressing the intermediate transfer belt from the outside thereof. The transferor transfers the toner image on the intermediate transfer belt onto a sheet to be conveyed thereto when the sheet passes between the outer periphery surface of the intermediate transfer belt and a secondary transfer roller.

It is currently known that when a sheet enters the transferor in the image forming apparatus, so-called shock noise occurs in which noise such as horizontal lines is transferred onto the sheet. As a method of reducing this shock noise, a method is known in which a separation amount between the intermediate transfer belt and the transfer roller is increased at the time of entry into the transferor to reduce the shock noise.

In addition, the image forming apparatus described in Japanese Patent Publication Laid-Open No. 2014-071330 is known as an apparatus that adjusts a separation amount between an intermediate transfer belt and a transfer roller. In this image forming apparatus, pre-printing is performed before main printing, a conveyance speed of the sheet is detected in the pre-printing, and, based on this result of the detected conveyance speed, the separation amount between the intermediate transfer belt and the transfer roller with respect to the sheet to be printed in the main printing is automatically adjusted.

However, in the image forming apparatus of the related art, the speed of the sheet detected in the pre-printing is used in the main printing, there is a problem that it is not possible to cope with the speed of the sheet depending on the type of the sheet or the state of the sheet in the main printing and shock noise occurs. In addition, since waste sheet is also generated, it is also desired to suitably perform printing without using waste sheet.

### SUMMARY

An object of the present invention is to provide an image forming apparatus capable of reducing shock noise generated during transfer and performing printing suitably.

In order to achieve at least one of the above-described objects, an image forming apparatus reflecting one aspect of the present invention includes:

a transferor that includes a transfer body and a roller facing the transfer body, where the transfer body and the roller hold a recording material between the transfer body and the roller, the transfer body transfers an image onto the recording material, and the recording material has a sheet shape and is conveyed;

a characteristic detector that detects characteristic information corresponding to a recording material characteristic of the recording material that is conveyed to the transferor; and

at least one hardware processor.

The at least one hardware processor performs adjustment, in which a pressing force between the transfer body and the roller or an interval between the transfer body and the roller is adjusted, at the transferor based on the detected characteristic information.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus according to an embodiment of the present invention;

FIG. 2 is a system block diagram of the image forming apparatus according to an embodiment of the present invention;

FIG. 3 is a functional block diagram of a controller in the image forming apparatus according to an embodiment of the present invention;

FIG. 4 is a functional block diagram illustrating a configuration of a main part of a detection apparatus according to an embodiment of the present invention; and

FIG. 5 is a flowchart illustrating operations of the image forming apparatus according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of an image forming apparatus to which the present invention is applied will be described with reference to the accompanying drawings.

### <Configuration of Image Forming Apparatus>

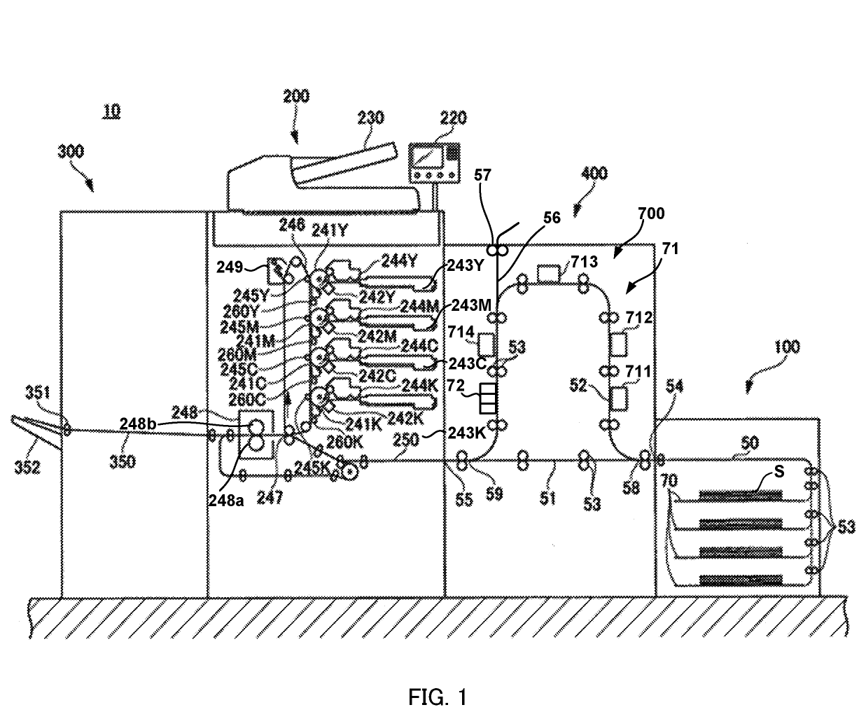

The configuration of an image forming apparatus according to an embodiment will be described with reference to FIG. 1.

FIG. 1 is a diagram illustrating a schematic configuration of an image forming apparatus according to an embodiment.

As illustrated in FIG. 1, an image forming apparatus 10 includes a recording material supplying apparatus 100, a recording material conveying apparatus 400, an image forming apparatus main body 200, and a post-processing apparatus 300.

In a case where an image is formed on a recording material S in the image forming apparatus 10, the recording material S having a sheet shape such as a sheet is first supplied from the recording material supplying apparatus 100 to the recording material conveying apparatus 400. Then, the recording material conveying apparatus 400 conveys the recording material S to the image forming apparatus main body 200. Note that, the recording material conveying apparatus 400 includes a characteristic detector (“first detector 71”, “second detector 72”) that measures characteristics of the recording material S. Note that, a characteristic represents characteristic information indicating the characteristic, and examples of the characteristics of the sheet include the thickness of the sheet, the moisture content of the sheet, the stiffness of the sheet, the basis weight of the sheet or the resistance of the sheet, the surface properties (smoothness) of the sheet, and the size of the sheet. The characteristics are also physical property values indicating physical properties.

Next, the image forming apparatus main body 200 forms an image on the recording material S that has been supplied. Then, the image forming apparatus main body 200 sends the recording material S, on which the image has been formed, to the post-processing apparatus 300. The post-processing apparatus 300 performs predetermined post-processing on the recording material S on which the image has been formed. Thereafter, the post-processing apparatus 300 ejects the recording material S.

### [Recording Material Supplying Apparatus]

The recording material supplying apparatus 100 accommodates the recording material (print medium) S for image formation. Upon receiving an image formation job from a controller 90, which will be described later, of the image forming apparatus 10, the recording material supplying apparatus 100 supplies the recording material S corresponding to the image formation job to the recording material conveying apparatus 400. The recording material supplying apparatus 100 includes a conveyor 50 and a recording material supplier 70.

The recording material supplier 70 includes a plurality of recording material storages. The plurality of recording material storages individually accommodates recording materials S different in type and size. In the present embodiment, the recording material S is a recording medium (print medium) on which an image is formed, and is, for example, a sheet. The recording material S may be any material other than a sheet as long as at least one of the thickness, the moisture content, the stiffness, the basis weight, and/or the resistance among the above-described characteristics can be measured.

The conveyor 50 includes a plurality of take-out rollers (not illustrated) that takes out the recording material S from the recording material supplier 70, and a plurality of conveyance rollers 53. The plurality of conveyance rollers 53 is provided along a predetermined recording material conveyance path. The plurality of conveyance rollers 53 conveys recording materials S taken out from the recording material supplier 70 to the recording material conveying apparatus 400 one by one.

### [Recording Material Conveying Apparatus]

The recording material conveying apparatus 400 includes an inlet port 54, an outlet port 55, a first conveyor 51, a second conveyor 52, a third conveyor 56, an ejector 57, the first detector 71 (711, 712, 713, 714), and the second detector 72.

The inlet port 54 allows the recording material S supplied from the recording material supplying apparatus 100 to be conveyed inward therethrough. The first conveyor 51, the second conveyor 52, and the third conveyor 56 convey the recording material S conveyed inward through the inlet port 54 to the outlet port 55 or the ejector 57. The first conveyor 51, the second conveyor 52, and the third conveyor 56 include a plurality of the conveyance rollers 53 for conveying the recording material S.

Each of the first detector 71 and the second detector 72 acquires characteristic information of the recording material S. Specifically, the first detector 71 and the second detector 72 include medium sensors that measure characteristics of the recording material S. The medium sensor measures various characteristics of the recording material S, that is, characteristic information indicating the characteristics, which are so-called physical property values indicating the physical properties, and outputs a measured physical value(s) as the characteristic information to the controller 90.

With respect to the characteristic information of the recording material S, at least one of the thickness, the moisture content, the stiffness, the basis weight, the surface properties (smoothness), the resistance, and/or the like of the recording material is acquired as the characteristic information of the recording material S. The characteristic information may also include the size of the recording material S. In particular, the stiffness is an index indicating the resistance property when the recording material S is bent, and can be represented by various physical quantities.

The recording material conveying apparatus 400 includes a branch 58 that branches the conveyance route of the recording material S. The recording material conveying apparatus 400 includes a first conveyance route formed in the first conveyor 51 and a second conveyance route formed in the second conveyor 52, which are branched from the branch 58, and an ejection (purge) route formed in the third conveyor 56, which is branched from the second conveyance route.

The first conveyance route is a route that is disposed upstream of the outlet port 55 and connects the inlet port 54 and the outlet port 55. The first conveyance route branches at the branch 58 and then merges with the second conveyance route (the second conveyor 52) at a merging portion 59 to communicate with the outlet port 55.

The second conveyance route is a route upstream of the outlet port 55 and for acquiring characteristic information of the sheet S to be conveyed. The second conveyance route is provided with each medium sensor (the first detector 71, the second detector 72) that measures characteristics of the sheet S passing through the second conveyance route. The recording material S that has been conveyed along the second conveyance route is ejected from the outlet port 55 via the merging portion 59 or ejected (purged) to the outside via the ejection route, after a characteristic(s) of the recording material S is/are acquired as characteristic information. Note that, the acquisition of the characteristic information of the recording material S in the second conveyance route may take place by performing measurement in a state in which the recording material S stops on the second conveyance route or by performing measurement while the recording material S is moving.

The ejection route is a route which is formed in the third conveyor 56 that is a conveyor branched from the second conveyor, and through which the recording material S having a characteristic inappropriate for image formation (for example, a characteristic of an extremely large moisture content) is ejected (purged) to the outside of the conveyance route. The third conveyor 56 allows the recording material S to be purged before the recording material S is conveyed into the image forming apparatus main body 200 through the outlet port 55.

### [Image Forming Apparatus Main Body]

The image forming apparatus main body 200 includes an operation display 220, a scanner 230, an image former 240, and a conveyor 250.

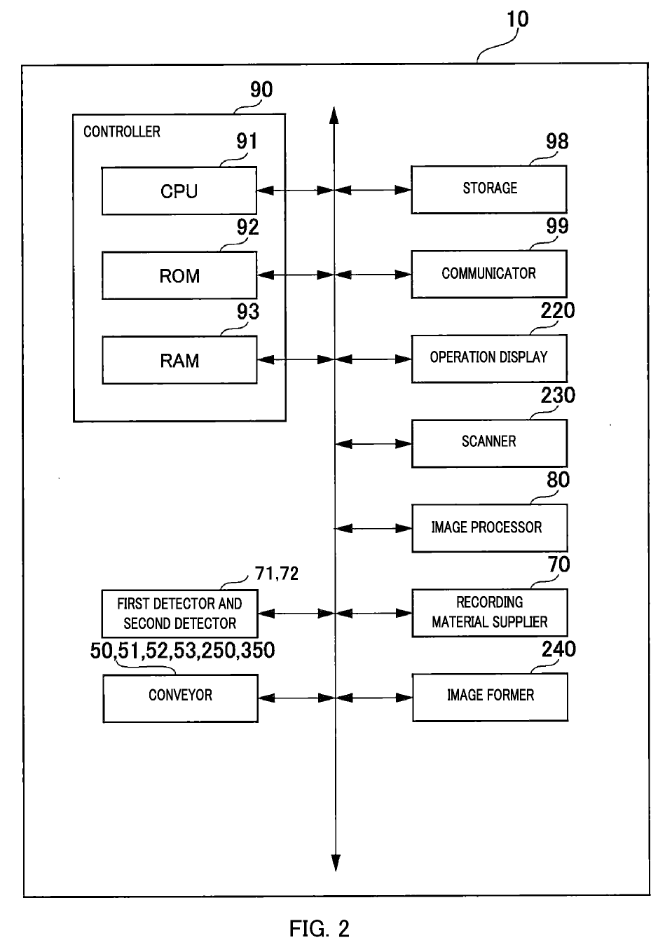

The operation display 220 includes an operator and a display. The display is constituted by, for example, a display apparatus such as a liquid crystal display (LCD). The display displays various screens according to an instruction of a display signal input from the controller 90 (see FIG. 2) to be described later. The operator includes a touch screen formed so as to cover the display screen of the display, and various operation buttons such as numeric buttons and a start button. The operator receives an operation instruction from the user. The operator outputs an operation signal based on a user operation to the controller 90 to be described later.

The scanner 230 includes an automatic document feeding apparatus called an auto document feeder (ADF), and a document image scanning apparatus (scanner). The automatic document feeding apparatus conveys a document, which has been placed on a document tray, by a conveyance mechanism and feeds out the document to the document image scanning apparatus. The document image scanning apparatus optically scans a document conveyed onto a contact glass by the automatic document feeding apparatus or a document placed on the contact glass by the user. The document image scanning apparatus forms an image of reflected light from the scanned document on a light receiving surface of a charge coupled device (CCD) sensor or the like. Thus, the document image scanning apparatus reads an image of the document. The scanner 230 generates image data based on a reading result by the document image scanning apparatus.

The image former 240 forms an image on the recording material S based on image data. The image former 240 includes photoreceptor drums 241Y, 241M, 241C, and 241K corresponding to colors of yellow (Y), magenta (M), cyan (C), and black (K), respectively. The image former 240 further includes electric chargers 242Y, 242M, 242C, and 242K, exposers 243Y, 243M, 243C, and 243K, developers 244Y, 244M, 244C, and 244K, and primary transfer rollers 245Y, 245M, 245C, and 245K. The image former 240 further includes an intermediate transfer belt 246, a secondary transfer roller 247, and a fixer 248.

Hereinafter, the photoreceptor drums 241Y, 241M, 241C, and 241K are collectively referred to as the “photoreceptor drum 241”. Further, the electric chargers 242Y, 242M, 242C, and 242K are collectively referred to as the “electric charger 242”, and the exposers 243Y, 243M, 243C, and 243K are collectively referred to as the “exposer 243”. In addition, the developers 244Y, 244M, 244C, and 244K are collectively referred to as the “developer 244”, and the primary transfer rollers 245Y, 245M, 245C, and 245K are collectively referred to as the “primary transfer roller 245”.

The photoreceptor drum 241 is an image carrier that carries a toner image thereon. The photoreceptor drum 241 is driven by a photoreceptor driving motor (not illustrated) to rotate. Around the photoreceptor drum 241, the electric charger 242, the exposer 243, and the developer 244 are disposed in this order from the upstream side of the photoreceptor drum 241 in the rotation direction thereof to the downstream side of the photoreceptor drum 241 in the rotation direction thereof. The electric charger 242 uniformly charges the photoreceptor drum 241.

The exposer 243 is constituted by a laser light source, a polygon mirror, a lens, and the like. The exposer 243 scans and exposes the surface of the photoreceptor drum 241 with a laser beam to form an electrostatic latent image. The scanning exposure by the exposer 243 is performed based on image data read by the scanner 230 or image data received from an external apparatus.

The developer 244 develops an electrostatic latent image formed on the photoreceptor drum 241 by causing the toner of each color to adhere thereto. Thus, a toner image is formed on an image-carrying surface of the photoreceptor drum 241. That is, toner images of yellow, magenta, cyan, and black are formed on the image-carrying surfaces of the photoreceptor drums 241Y, 241M, 241C, and 241K, respectively.

The intermediate transfer belt 246 is stretched around a plurality of belt support rollers and is disposed in a loop shape. In the movement route of the intermediate transfer belt 246, the primary transfer rollers 245, the secondary transfer roller 247, a discharging roller (not illustrated), and a cleaning unit 249 are disposed.

The outer periphery surface of the intermediate transfer belt 246 is an image-carrying surface and is disposed in a state of being in contact with the outer periphery surface of the photoreceptor drum 241. The intermediate transfer belt 246 rotates in the direction opposite to that of the rotation of the photoreceptor drum 241. Specifically, the photoreceptor drum 241 rotates counterclockwise in FIG. 1, and the intermediate transfer belt 246 rotates clockwise in FIG. 1.

The primary transfer roller 245 is disposed at a position facing the photoreceptor drum 241. The primary transfer roller 245 is disposed on the inner peripheral side of the intermediate transfer belt 246, and the primary transfer roller 245 and the photoreceptor drum 241, which the primary transfer roller 245 faces, hold the intermediate transfer belt 246 therebetween.

The primary transfer roller 245 applies electric charge having a polarity opposite to that of the toner to the intermediate transfer belt 246 to cause the toner adhering to the image-carrying surface of the photoreceptor drum 241 to be transferred onto the image-carrying surface of the intermediate transfer belt 246 (primary transfer). Thus, a color toner image in which the toner images of the four colors are superimposed on one another is formed on the toner image-carrying surface of the intermediate transfer belt 246.

The secondary transfer roller (roller) 247, together with the intermediate transfer belt (transfer body) 246 and the support roller that supports the intermediate transfer belt 246 from the inside thereof, forms a second transferor (transferor). Note that, the second transferor may be referred to as a transfer nip.

The secondary transfer roller 247 causes the color toner image on the image-carrying surface of the intermediate transfer belt (transfer body) 246 to be collectively transferred onto one recording surface of the recording material S (secondary transfer). The secondary transfer roller 247 and a belt support roller (support roller) hold the intermediate transfer belt 246 therebetween.

The position at which the secondary transfer roller 247 and the belt support roller, which constitute the transfer nip, face each other is a transfer position at which the toner image transferred onto the image-carrying surface of the intermediate transfer belt 246 is transferred onto the recording material S. The sheet S enters this transfer position and is nipped between the intermediate transfer belt 246 and the secondary transfer roller 247, and thus, the image is transferred onto the sheet S. At this time, the separation amount between the secondary transfer roller 247 and the intermediate transfer belt 246 as well as the pressing force of the secondary transfer roller 247 are adjusted according to a characteristic(s) of the recording material S that makes the entry by the conveyance.

The cleaning unit 249 is disposed upstream of the primary transfer roller 245 and downstream of the discharging roller (not illustrated) in the rotation direction of the intermediate transfer belt 246. The cleaning unit 249 removes toner remaining on the image-carrying surface of the intermediate transfer belt 246.

The fixer 248 includes a fixing roller 248a and a pressure roller 248b. A heater is built in the fixing roller 248a. The pressure roller 248b is pressed against the fixing roller 248a. Thus, the fixing roller 248a and the pressure roller 248b are crimped to each other, and a fixing nip is formed in this crimping portion. The recording material S is heated and pressurized when passing through the fixing nip. Thus, the toner image transferred onto the recording material S is fixed.

The conveyor 250 includes a plurality of the conveyance rollers 53 for conveying the recording material S along a predetermined conveyance route. The conveyor 250 conveys the recording material S supplied from the recording material conveying apparatus 400 to the transfer position. Further, the conveyor 250 conveys the recording material S after image formation to the post-processing apparatus 300.

### [Post-Processing Apparatus]

The recording material S on which an image has been formed in the image forming apparatus main body 200 is conveyed into the post-processing apparatus 300. The post-processing apparatus 300 includes a plurality of post-processing units, a conveyor 350, an ejector 351, and a sheet ejection tray 352.

Upon receiving a post-processing job from the controller 90 to be described later, the post-processing apparatus 300 executes predetermined post-processing in a post-processing unit specified by the post-processing job. Examples of the post-processing include perforation processing, folding processing, foil stamping, binding, cutting processing, stapling, gluing, and binding.

The conveyor 350 includes a plurality of conveyance rollers (not illustrated) for conveying the recording material S along a predetermined conveyance route. The conveyor 350 conveys the recording material S supplied from the image forming apparatus main body 200 to a post-processing unit corresponding to the type of post-processing to be executed. Further, the conveyor 350 conveys the recording material S subjected to the post-processing, and ejects the recording material S from the ejector 351. The recording material S ejected from the ejector 351 is placed on the sheet ejection tray 352.

### [Control System of Image Forming Apparatus 10]

Next, an example of the configuration of the control system of the image forming apparatus 10 will be described with reference to FIG. 2.

FIG. 2 is a functional block diagram of the image forming apparatus 10.

The image forming apparatus 10 includes the controller 90, a storage 98, a communicator 99, the operation display 220, the scanner 230, an image processor 80, the recording material supplier 70, the image former 240, the first and second detectors 71 and 72, and the conveyors 50, 250, and 350. In addition, the image forming apparatus 10 includes the first conveyor 51, the second conveyor 52, and the third conveyor 56 as the conveyor. Hereinafter, a description of configurations overlapping with those described for the image forming apparatus 10 illustrated in FIG. 1 above will be omitted.

The controller 90 is constituted by, for example, a central processing unit (CPU) 91, a read only memory (ROM) 92, a random access memory (RAM) 93, and the like. The CPU 91 reads various processing programs stored in the ROM 92, develops the programs in the RAM 93, and performs centralized control of the operation of each unit of the image forming apparatus 10 according to the developed programs.

The ROM 92 stores various processing programs for controlling each unit of the image forming apparatus 10, parameters and table data necessary for executing the programs, various files, and the like.

The RAM 93 is constituted by a volatile memory. In various processing that is executed and controlled by the CPU 91, the RAM 93 forms a work area for temporarily storing various processing programs, inputs or outputs, parameters, and the like read from the ROM 92.

The storage 98 stores, for example, image data or the like received from an external apparatus. Further, the storage 98 stores various processing programs to be executed by the CPU 91 and information on processing functions of the own apparatus necessary for executing the programs. In addition, the storage 98 stores image data input from a client apparatus (not illustrated) or the like, such as image data read by the scanner 230. Further, the storage 98 stores characteristic information of the recording material S (the size, thickness, moisture content, stiffness, basis weight, or resistance of the recording material S) measured by the first detector 71 and the second detector 72. The storage 98 may be constituted by, for example, a non-volatile memory such as a hard disk drive (HDD), a solid state drive (SSD), or a flash memory.

The communicator 99 is constituted by a network interface card (NIC), a modem, and the like. The communicator 99 connects the recording material supplying apparatus 100, the recording material conveying apparatus 400, the image forming apparatus main body 200, the post-processing apparatus 300, the first detector 71, and the second detector 72 to a communication network. The communication network is a local area network (LAN), a wide area network (WAN), or the like. In addition, the communicator 99 performs transmission and reception of various data between each apparatus and an external information device (for example, a client apparatus).

As described above, the operation display 220 functions as the display and the operator. The display displays various types of operation screens according to display control signals input from the controller 90. The operator receives various types of input operations by the user, and outputs operation signals corresponding to the various input operations to the controller 90.

The scanner 230 outputs a read image (analog image signal) to the image processor 80.

The image processor 80 includes a circuit that performs analog-to-digital (A/D) conversion processing and a circuit that performs digital image processing. The image processor 80 performs A/D conversion processing on an analog image signal supplied from the scanner 230 to generate digital image data.

In addition, the image processor 80 analyzes a print job acquired from an external information device (for example, a client apparatus), rasterizes each page of a document, and generates digital image data. Further, the image processor 80 performs image processing, such as color conversion processing, correction processing (shading correction or the like) corresponding to initial setting or user setting, and compression processing, on image data as necessary. The image processor 80 outputs the image data after the image processing to the image former 240.

The first detector 71 and the second detector 72 include a plurality of medium sensors that measures characteristics (physical property values) of the recording material S. The first detector 71 and the second detector 72 are provided in the recording material conveying apparatus 400 (see FIG. 1). When the first detector 71 and the second detector 72 receive a characteristic measurement signal indicating a characteristic(s) of the recording material S output by the controller 90, the first detector 71 and the second detector 72 measure the characteristic(s) of the recording material S corresponding to the received signal in the recording material S. Further, a sheet characteristic detection apparatus 700 outputs a measurement result to the controller 90.

### [Functional Configuration of Controller]

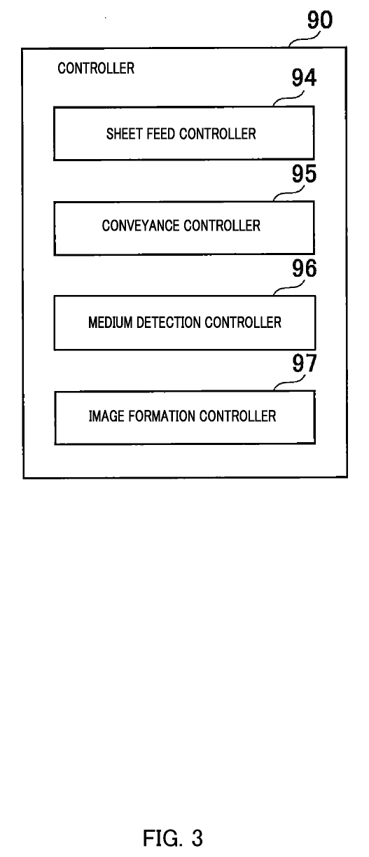

Next, the functional configuration of the controller 90 will be described with reference to FIG. 3.

FIG. 3 is a functional block diagram of the controller 90.

As illustrated in FIG. 3, the controller 90 includes a sheet feed controller 94, a conveyance controller 95, a medium detection controller 96, and an image formation controller 97.

The sheet feed controller 94 controls supply of the recording material S from the recording material supplier 70 to the conveyor 50 in the recording material supplying apparatus 100. The sheet feed controller 94 causes the recording material S to be supplied to the conveyor 50 in line with conveyance control of the recording material S by the conveyance controller 95.

The conveyance controller 95 controls the driving of the conveyors (50, 51, 52, 53, 250, and 350) provided in the recording material supplying apparatus 100, the recording material conveying apparatus 400, the image forming apparatus main body 200, and the post-processing apparatus 300. Thus, the recording material S is conveyed to each portion of the image forming apparatus 10. Further, the conveyance controller 95 controls the conveyance mechanism such as the branch 58 in the recording material conveying apparatus 400 to change the conveyance route of the recording material S. The conveyance controller 95 controls the driving of the first conveyor 51 and the second conveyor 52 among the conveyors in cooperation with the medium detection controller 96 to cause the recording material S to be conveyed, and allows the recording material S to be purged by using the third conveyor 56.

When the recording material S is conveyed in response to an image formation job, the conveyance controller 95 causes at least one sheet of the recording material S to be guided to the second conveyance route in which the second conveyor 52 of the recording material conveying apparatus 400 performs the conveyance. Then, in the second conveyance route, each characteristic of the recording material S is measured by the first detector 71 and the second detector 72.

The conveyance controller 95 corrects a control parameter(s) related to the conveyance of the recording material S according to the stiffness of the recording material S. As a specific example of the control parameters related to the conveyance, it is possible to mention the conveyance speed of the recording material S.

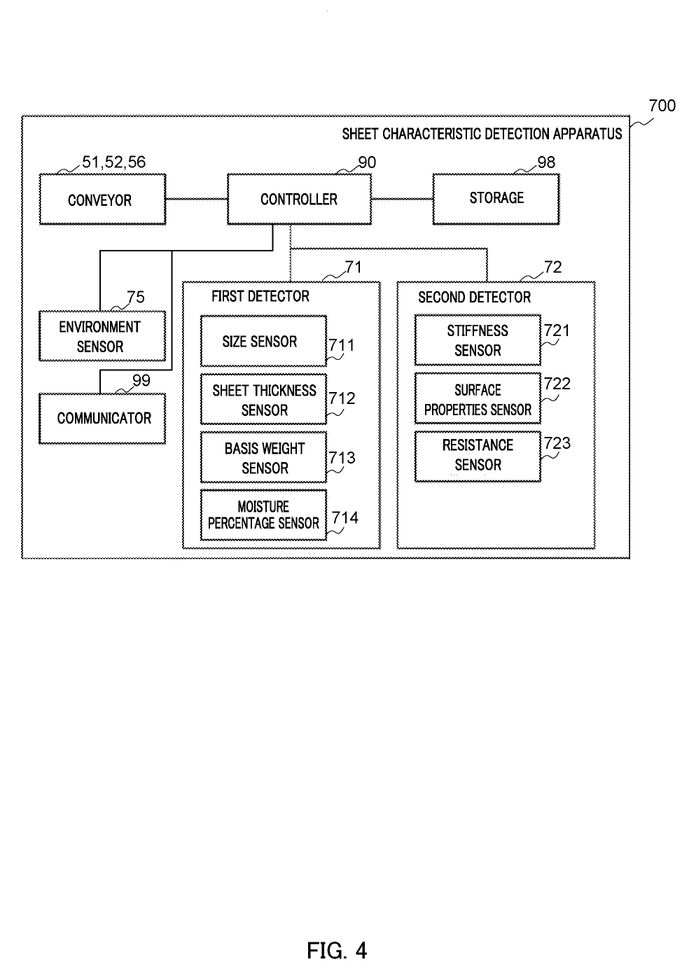

The medium detection controller 96 controls the first detector 71 and the second detector 72. Specifically, the medium detection controller 96 controls the first detector 71 and the second detector 72 as part of the sheet characteristic detection apparatus 700 (see FIG. 4) included in the image forming apparatus.

The image formation controller 97 controls the image formation operation of the image former 240. In addition, the image formation controller 97 determines a control parameter(s) related to the image formation according to the characteristic(s) of the recording material S measured by the first detector 71 and the second detector 72.

Examples of the control parameters related to the image formation include a charged electric potential by the electric charger 242, transfer currents to be supplied to the primary transfer roller 245 and the secondary transfer roller 247, and a fixing temperature and a fixing pressure at the fixer 248.

In particular, in cooperation with the medium detection controller 96, the image formation controller 97 controls the driving of the secondary transfer roller 247 in the image former 240 according to a characteristic(s) of the recording material S. The driving of the secondary transfer roller 247 is controlled, and thus, the pressing force thereof to the intermediate transfer belt 246 is adjusted and the distance between the intermediate transfer belt 246 and the secondary transfer roller 247 is adjusted.

According to a characteristic(s) of the recording material, the image formation controller 97 performs adjustment at the transfer nip, in which the separation amount between the intermediate transfer belt 246 and the secondary transfer roller 247 or the pressing force of the secondary transfer roller 247 against the intermediate transfer belt 246 is adjusted, via the image former 240.

### <Configuration of Sheet Characteristic Detection Apparatus 700>

Next, in the image forming apparatus 10, the sheet characteristic detection apparatus included in the image forming apparatus 10 will be described with reference to FIG. 4. FIG. 4 is a functional block diagram illustrating a schematic configuration of the sheet characteristic detection apparatus 700 in the image forming apparatus. Note that, hereinafter, a description of configurations overlapping with those described for the image forming apparatus 10 and the controller 90 illustrated in FIGS. 2 and 3 above will be omitted.

The sheet characteristic detection apparatus 700 is configured by the respective constituent requirements for the image forming apparatus 10, and controls, by the configuration of the image forming apparatus 10, the nip state at the second transferor according to the sheet characteristics itself of a sheet on which an image is formed.

The sheet characteristic detection apparatus 700 includes conveyors (mainly the first conveyor 51, the second conveyor 52, and the third conveyor 56), the controller 90, the storage 98, the first detector 71 and the second detector 72 which are the detector, an environment sensor 75, and the communicator 99.

The first conveyor 51, the second conveyor 52, and the third conveyor 56 are disposed in the recording material conveying apparatus 400. Mainly, the second conveyor 52 conveys the recording material S whose characteristics have been detected to the outlet port 55, ejects the recording material S from the outlet port 55, and conveys the recording material S to the second transferor.

The controller 90 mainly includes the medium detection controller 96 (see FIG. 3), causes the first detector 71 and the second detector 72 to measure characteristics (indicating physical properties; stiffness, moisture percentage, thickness, basis weight, size, surface properties, and resistance) of the recording material S, and outputs characteristic information indicating a measured characteristic(s) to the controller 90. In addition, the medium detection controller 96 of the controller 90 determines whether the detected physical property information (a physical property value) is a value within a predetermined range (a range in which adjustment can be performed at the second transferor). In a case where the detected physical property information is outside the predetermined range, the medium detection controller 96 controls the driving of the second conveyor 52 and the third conveyor 56 of the conveyor by the conveyance controller 95 to cause the recording material S to be ejected to the outside.

Based on the measured characteristic information, the controller 90 controls, by the image formation controller 97, the driving of the secondary transfer roller 247 in the second transferor via the image former 240 to adjust its pressing degree or the separation amount between the secondary transfer roller 247 and the intermediate transfer belt 246 to cause adjustment at the transfer nip to be performed.

The controller 90 reads adjustment information at the secondary transferor (the pressing force of the secondary transfer roller 247 against the intermediate transfer belt 246 or the separation amount between the intermediate transfer belt 246 and the secondary transfer roller 247), which corresponds to characteristic information of the recording material S stored in the storage 98. The controller 90 controls the driving of the second transferor with the adjustment information corresponding to a measured characteristic(s).

The first detector 71 includes a size sensor 711, a sheet thickness sensor 712, a basis weight sensor 713, and a moisture percentage sensor 714 as medium sensors that measure characteristics of the recording material S. The size sensor 711 measures the size of the recording material S conveyed along the second conveyance route of the second conveyor 52, and the sheet thickness sensor 712 measures the thickness of the same recording material S. In addition, the basis weight sensor 713 measures the basis weight of the same recording material S, and the moisture percentage sensor 714 measures the moisture content in the same recording material S. Each of the sensors 711 to 714 outputs the measured information to the controller 90. Note that, the installation locations of the sensors 711 to 714 and the second detector 72 in FIG. 1 may be provided anywhere in the second conveyance route of the second conveyor 52 as long as characteristics of the recording material S can be measured.

The second detector 72 includes a stiffness sensor 721, a surface properties sensor 722, and a resistance sensor 723 as medium sensors that measure characteristics of the recording material S.

The stiffness sensor 721 measures the stiffness of the recording material S conveyed along the second conveyance route of the second conveyor 52, the surface properties sensor 722 measures the surface properties (smoothness) of the same recording material S, and the resistance sensor 723 measures the resistance of the same recording material S. Characteristic information indicating a characteristic(s) of each recording material S, which is/are the stiffness, the surface properties and/or the resistance measured by each of the sensors 721 to 723 is output to the controller 90.

The environment sensor 75 measures the state of the environment in which the image forming apparatus 10 is installed, and is, for example, a sensor that measures at least humidity among humidity, temperature, and the like of the space in which the image forming apparatus 10 is installed, and outputs the measured at least humidity as environment information to the controller 90.

Using the information acquired by the environment sensor 75, the controller 90 ensures the accuracy of the moisture content or the like which is one of the characteristics of the recording material S, and based on this information, for example, the moisture content of the recording material S is more clearly estimated, and correspondingly, the adjustment at the second transferor can be more suitably performed.

### [Adjustment at Second Transferor]

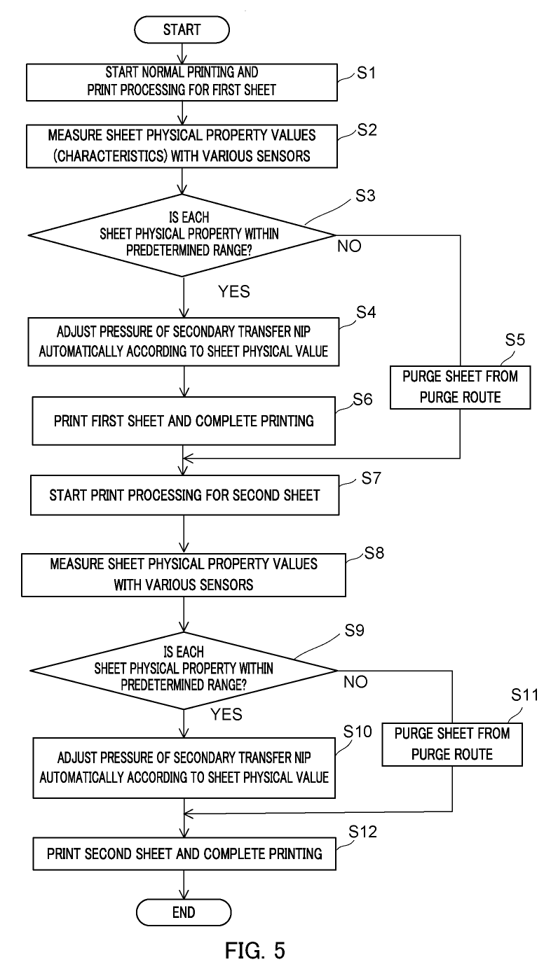

Next, processing of the image forming apparatus 10 according to the present embodiment, mainly processing of the sheet characteristic detection apparatus 700, will be described with reference to FIG. 5.

FIG. 5 is a flowchart illustrating operations of the image forming apparatus according to an embodiment of the present invention.

When a print instruction such as whether the number of sheets as the recording material S that is a print medium on which an image is formed is one or more is input via the operation display 220, a print job is started by the controller 90, and print processing for the first sheet is started (S1: START NORMAL PRINTING AND PRINT PROCESSING FOR FIRST SHEET). In step S1, when the print job is started, the sheet feed controller 94 feeds the recording material S to the conveyor 50 in line with the conveyance control of the recording material S by the conveyance controller 95, to start print processing for the first sheet.

The recording material S is conveyed into the recording material conveying apparatus 400 via the inlet port 54 by the conveyor 50, and is conveyed along the second conveyance route by the second conveyor 52.

In step S2, the medium detection controller 96 of the controller 90 measures characteristics (physical property values indicating physical properties) of the recording material S as a sheet with the various sensors (711 to 714 and 721 to 723) of the first detector 71 and the second detector 72.

The various sensors (medium sensors) are the size sensor 711, the sheet thickness sensor 712, the basis weight sensor 713, the moisture percentage sensor 714, the stiffness sensor 721, the surface properties sensor 722, the resistance sensor 723, and the like. The various sensors (711 to 714 and 721 to 723) measure physical properties (physical property values) of the recording material S, and output the measured physical properties to the controller 90 (the medium detection controller 96).

In step S3, the medium detection controller 96 determines whether each sheet physical property (the detected physical property information) of the recording material S that is a sheet is within a predetermined range (within a range in which adjustment at the second transferor can be performed) with the various sensors. Note that, this step S3 also includes the determination of whether a sheet characteristic(s) (sheet physical property/properties) could be detected.

In step S3, when each characteristic (characteristic information indicating each characteristic; each physical property value) is a value within the predetermined range, the processing proceeds to step S4, and when each characteristic is a value outside the predetermined range, the processing proceeds to step S5, the recording material S which is a sheet is purged from the purge route, and the processing proceeds to step S7.

In step S4, the controller 90 adjusts (automatically adjusts) the separation amount between the secondary transfer roller 247 and the intermediate transfer belt (transfer body) 246 and the pressing force of the secondary transfer roller 247 at the second transferor according to the characteristics of the sheet detected by the medium detection controller 96. That is, the image formation controller 97 performs adjustment at the transfer nip.

For example, since the conveyance speed decreases in a case where the moisture content of the sheet is greater than that set in advance, the pressing force (separation amount) of the secondary transfer roller 247 is adjusted so as to be weaker than a normal setting for the sheet. In addition, since the conveyance speed increases in a case where the stiffness of the sheet is higher than that set in advance, the pressing force (separation amount) of the secondary transfer roller 247 is adjusted so as to be stronger than the normal setting for the sheet.

Further, in a case where the thickness of the sheet is thicker than the set sheet thickness, the conveyance speed of the thick sheet increases more than that of a thin sheet, and thus, the pressing force (separation amount) of the secondary transfer roller 247 is adjusted to be stronger than that of the thin sheet. In addition, since the conveyance speed increases in a case where the basis weight of the sheet is greater than that set in advance, the pressing force of the secondary transfer roller 247 is adjusted so as to be greater than a set value.

The image formation controller 97 adjusts the nip at the second transferor, that is, adjusts (automatically adjusts) the pressure of the secondary transfer roller 247 against the intermediate transfer belt (transfer body) 246 and the separation amount between the secondary transfer roller 247 against the intermediate transfer belt (transfer body) 246 according to the sheet physical property/properties. Note that, specifically in the processing in step S4, the image formation controller 97 reads adjustment information (pressing force and separation amount) at the second transferor, which corresponds to the detected characteristic information (physical property value(s)), and controls the driving of the second transferor via the image former 240 with the read adjustment information.

In step S6, the image formation controller 97 controls the driving of the second transferor via the image former 240 to adjust the pressing force of the secondary transfer roller (roller) 247 or the separation amount between the secondary transfer roller (roller) 247 and the intermediate transfer belt (transfer body) 246.

The image forming control unit 97 causes the recording material S to enter the second transferor whose separation amount has been adjusted, causes the image to be transferred onto the recording material S, causes the image to be formed on the recording material S, and ends the printing of the first sheet of the recording material S.

Next, in step S7, the controller 90 starts the print processing for the second sheet. At the controller 90, the sheet feed controller 94 feeds the recording material S to the conveyor 50 according to the conveyance control of the recording material S by the conveyance controller 95, to start print processing for the second sheet.

The conveyor 50 conveys the recording material S into the recording material conveying apparatus 400 via the inlet port 54. The recording material S conveyed into the recording material conveying apparatus 400 is conveyed along the second conveyance route by the second conveyor 52.

In step S8, the medium detection controller 96 in the controller 90 measures sheet characteristics (physical property values indicating physical properties) of the recording material S by the various sensors (711 to 714 and 721 to 723) of the first detector 71 and the second detector 72. The physical properties (physical property values) of the recording material S measured by each sensor are output to the controller 90 (the medium detection controller 96).

In step S9, the medium detection controller 96 determines whether each sheet characteristic (each physical property; each physical property value) of the recording material S detected by the measurement is within a predetermined range (within a range in which adjustment at the second transferor can be performed). Note that, this step S9 also includes the determination of whether a sheet characteristic(s) (sheet physical property/properties) could be detected.

In step S9, when each characteristic (characteristic information indicating each characteristic; each physical property value) is a value within the predetermined range, the processing proceeds to step S10, and when each characteristic is a value outside the predetermined range, the processing proceeds to step S11, the recording material S is purged from the purge route, and the processing proceeds to step S12.

In step S10, the image formation controller 97 of the controller 90 adjusts (automatically adjusts) the pressure of the second transferor against the pressing roller at the second transferor according to the sheet physical property/properties, and the processing proceeds to step S12. Note that, specifically in the processing in step S10, the image formation controller 97 reads adjustment information (pressing force and separation amount) at the second transferor, which corresponds to the detected characteristic information (physical property value(s)), and controls the driving of the second transferor via the image former 240 with the read adjustment information.

In step S12, the image formation controller 97 controls the driving of the second transferor via the image former 240 to adjust the pressing force of the secondary transfer roller (roller) 247 or the separation amount between the secondary transfer roller (roller) 247 and the intermediate transfer belt (transfer body) 246.

The image formation controller 97 causes the recording material S to enter the second transferor whose separation amount has been adjusted, causes the image to be transferred onto the recording material S, causes the image to be formed on the recording material S, and ends the printing of the second sheet of the recording material S.

The image forming apparatus 10 measures physical property values indicating sheet characteristics of the recording material S, which is a print medium such as a sheet, with the various medium sensors for the thickness, moisture content, stiffness, basis weight, and resistance of the recording material S and automatically adjusts the separation amounts of the transfer nip in the crimping direction and the separating direction based on the measured physical property values.

Thus, at the transfer nip, no deviation occurs in the timing at which the recording material is held between the intermediate transfer belt 246 and the secondary transfer roller 247. Further, by causing the interval between the intermediate transfer belt 246 and the secondary transfer roller 247 to correspond to a characteristic(s) (thickness and/or the like) of the recording material, the image can be transferred without formation of shock noise on the recording material even when the recording material performs the entry.

As described above, the image forming apparatus 10 measures a characteristic(s) of a recording material to be printed and feeds back a physical property value(s) indicating the measured characteristic(s) to the secondary transferor. Thus, the pressure for holding the recording material during transfer at the secondary transferor can be adjusted on a sheet-by-sheet basis, making it possible to reduce shock noise without requiring pre-printing or waste sheet.

As described above, according to the image forming apparatus 10, it is possible to reduce shock noise generated during transfer and perform printing suitably.

Although specific examples of the present invention have been described in detail above, these are merely examples and do not limit the scope of claims. The technology described in the scope of claims includes various modifications and changes of the specific examples exemplified above.

According to the present invention, it is possible to reduce shock noise generated during transfer and perform printing suitably.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a transferor that includes a transfer body and a roller facing the transfer body, the transfer body and the roller holding a recording material between the transfer body and the roller, the transfer body transferring an image onto the recording material, the recording material having a sheet shape and being conveyed;
a characteristic detector that detects characteristic information corresponding to a recording material characteristic of the recording material that is conveyed to the transferor; and
at least one hardware processor, wherein
the at least one hardware processor performs adjustment at the transferor based on the detected characteristic information, the adjustment being adjustment in which a pressing force between the transfer body and the roller or an interval between the transfer body and the roller is adjusted.

2. The image forming apparatus according to claim 1, wherein
the recording material characteristic is at least one of a thickness, a moisture content, a stiffness, a basis weight, and/or a resistance of the recording material.

3. The image forming apparatus according to claim 1, wherein:
the characteristic detector is disposed upstream of the transferor in a conveyance path through which the recording material is conveyed to the transferor, and
the at least one hardware processor performs, on the recording material of which the characteristic information has been detected, the adjustment at the transferor based on the characteristic information detected upstream of the transferor.

4. The image forming apparatus according to claim 3, wherein
the characteristic detector detects the characteristic information of the recording material that is being conveyed in the conveyance path.

5. The image forming apparatus according to claim 4, wherein
the characteristic information includes at least one of a thickness, a moisture content, and/or a basis weight of the recording material.

6. The image forming apparatus according to claim 3, further comprising:
the conveyance path through which the recording material is conveyed to the transferor, the conveyance path being upstream of the transferor; and
a purge route which is disposed in the conveyance path and from which the recording material conveyable to the transferor is purged, wherein
in a case where the detected characteristic information of the recording material is outside a predetermined range, the at least one hardware processor purges, from the purge route, the recording material that is being conveyed.
